(19) United States
(12) Patent Application Publication
(10) Pub. No.: US 2006/0017800 A1
(43) Pub. Date: Jan. 26, 2006

(54) Exposure system

(75) Inventor: Hiroaki Hyuga, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/187,951

(22) Filed: Jul. 25, 2005

(30) Foreign Application Priority Data
Jul. 23, 2004 (JP) 215132/2004

(51) Int. Cl. B41J 2/45

(52) U.S. Cl. 347/238

(57) ABSTRACT

An exposure system includes a plurality of kinds of light emitting element arrays, each formed of a plurality of light emitting elements which are arranged in one row in one direction, which are arranged substantially normal to said one direction and emits light in different wavelength ranges, and a sub-scanning mechanism which holds a color photosensitive material in a position where the light from each of the light emitting element arrays is projected, and moves the color photosensitive material and the light emitting element arrays relatively to each other in the one direction. In the exposure system at least one of the plurality of kinds of light emitting element arrays is a multi-layered type light emitting element array or the light emitting area of the light emitting element is nonuniform between at least two kinds of light emitting element arrays.

### BACKGROUND OF THE INVENTION

1. Field of the Invention

This invention relates to an exposure system, and more particularly to an exposure system for exposing a color photosensitive material by the use of a plurality of kinds of light emitting element arrays emitting light in different wavelength ranges.

2. Description of the Related Art

As disclosed, for instance, in U.S. Pat. No. 6,731,322 and Japanese Unexamined Patent Publication No. 2001-260416, there has been known a system where a color photosensitive material is exposed to light by the use of an exposure head comprising a plurality of kinds of light emitting element arrays emitting light in different wavelength ranges, e.g., red, green and blue light.

Each of the light emitting element arrays generally comprises a plurality of organic EL (electroluminescence) elements which are arranged in one or more rows and emits light in the same wavelength range, and in the exposure head, a plurality of kinds of light emitting element arrays emitting light in different wavelength ranges are generally arranged in a direction substantially normal to the direction in which the light emitting elements are arranged in each of the light emitting element arrays and a lens array which converges light from each of the light emitting element arrays on the color photosensitive material is provided.

The exposure system using such an exposure head generally further comprises a sub-scanning means which holds the color photosensitive material in a position where the light from each of the light emitting element arrays is projected, and moves the color photosensitive material and the light emitting element arrays (together with the lens array when a lens array is provided) relatively to each other in the direction in which a plurality of light emitting element arrays are arranged.

Especially, in U.S. Pat. No. 6,731,322, there is disclosed a system in which the same place of the color photosensitive material can be exposed to light a multiple times by the use of a light emitting element array comprising a plurality of rows of the light emitting elements arranged side by side in the direction of the above-mentioned relative movement.

Further, as a light emitting element forming the light emitting element array in the exposure system of this type, there has been known a multi-layered type organic EL element where a plurality of light emitting structures are superposed one on another to form multiple layers as shown in Japanese Unexamined Patent Publication No. 2003-045676.

However, in the exposure system where a color photosensitive material is exposed to light by the use of a plurality of kinds of light emitting element arrays emitting light in different wavelength ranges, e.g., red, green and blue light, there has been a problem that the intensity ratio of light in the respective wavelength ranges fluctuate after a plurality of repeated exposures and color balance is shifted. When the color balance is shifted, a density unevenness extending in the sub-scanning direction can be generated in the exposed image at the worst.

Generation of the density unevenness can be prevented by discarding the exposure system immediately when the color balance is shifted. However this approach is disadvantageous in that the service life of the exposure system is governed by the service life of the light emitting element array which deteriorates at the highest speed in the parts of the exposure system.

Though problems in the exposure systems using arrays of self-luminous light emitting elements such as an organic EL element has been described, a similar problem can naturally arise in an exposure head using arrays of elements comprising a combination of a dimmer such as a liquid crystal or a PLZT and a light source. In this specification, the element comprising a combination of a dimmer and a light source will also be referred to as a “light emitting element” in view of that it emits the exposure light.

### SUMMARY OF THE INVENTION

In view of the foregoing observations and description, an aspect of the present invention is to provide an exposure system which can prevent the shift in color balance and is long in service life.

In accordance with the present invention, there is provided an exposure system comprising a plurality of kinds of light emitting element arrays, each formed of a plurality of light emitting elements which are arranged in one row in one direction, which are arranged substantially normal to said one direction and emits light in different wavelength ranges, and a sub-scanning means which holds a color photosensitive material in a position where the light from each of the light emitting element arrays is projected, and moves the color photosensitive material and the light emitting element arrays relatively to each other in said one direction in which a plurality of light emitting element arrays are arranged, wherein the improvement comprises that

at least one of the plurality of kinds of light emitting element arrays is a multi-layered type light emitting element array where a plurality of light emitting structures are superposed one on another.

In the exposure system of the present invention, since at least one of the plurality of kinds of light emitting element arrays is a multi-layered type light emitting element array where a plurality of light emitting structures are superposed one on another (the number of light emitting structures is assumed to be N), the light emitting brightness of one light emitting structure may be 1/N as compared with the non-multi-layered type usual light emitting element array to provide a given amount of exposure, whereby the service life of the light emitting element arrays is elongated to substantially N times and the service life of the exposure system is elongated.

When there is a difference in time constant of deterioration between the plurality of kinds of the light emitting element arrays due to difference in element structure, it is possible to equalize the light emitting element arrays in time constant of deterioration by changing the number N of layers of the superposed light emitting structures of the light emitting elements in the light emitting element arrays. If so, the intensity ratio of light in the respective wavelength ranges can be held constant even after a plurality of repeated exposures and shift of color balance can be prevented.

The same exposure can be obtained even if the light emitting brightness of one light emitting structure is 1/S by increasing the light emitting area of the light emitting element to S times. In accordance with the second exposure system of the present invention, the light emitting area of the light emitting element is nonuniform between at least two kinds of light emitting element arrays. Accordingly, when there is a difference in time constant of deterioration between the plurality of kinds of the light emitting element arrays due to difference in element structure, it is possible to equalize the light emitting element arrays in time constant of deterioration by changing the area S of the light emitting elements in the light emitting element arrays. If so, the intensity ratio of light in the respective wavelength ranges can be held constant even after a plurality of repeated exposures and shift of color balance can be prevented.

### BRIEF DESCRIPTION OF THE DRAWINGS

FIG. 1 is a side view of an exposure system in accordance with an embodiment of the present invention,

FIG. 2 is a schematic plan view of the exposure head of the exposure system,

FIG. 3 is a plan view showing the arrangement of the electrodes in the exposure head,

FIG. 4 is a view for illustrating the layer structure of the light emitting element of the exposure system, and

FIG. 5 is a plan view showing another example of the arrangement of the electrodes.

### DESCRIPTION OF THE PREFERRED EMBODIMENT

### First Embodiment

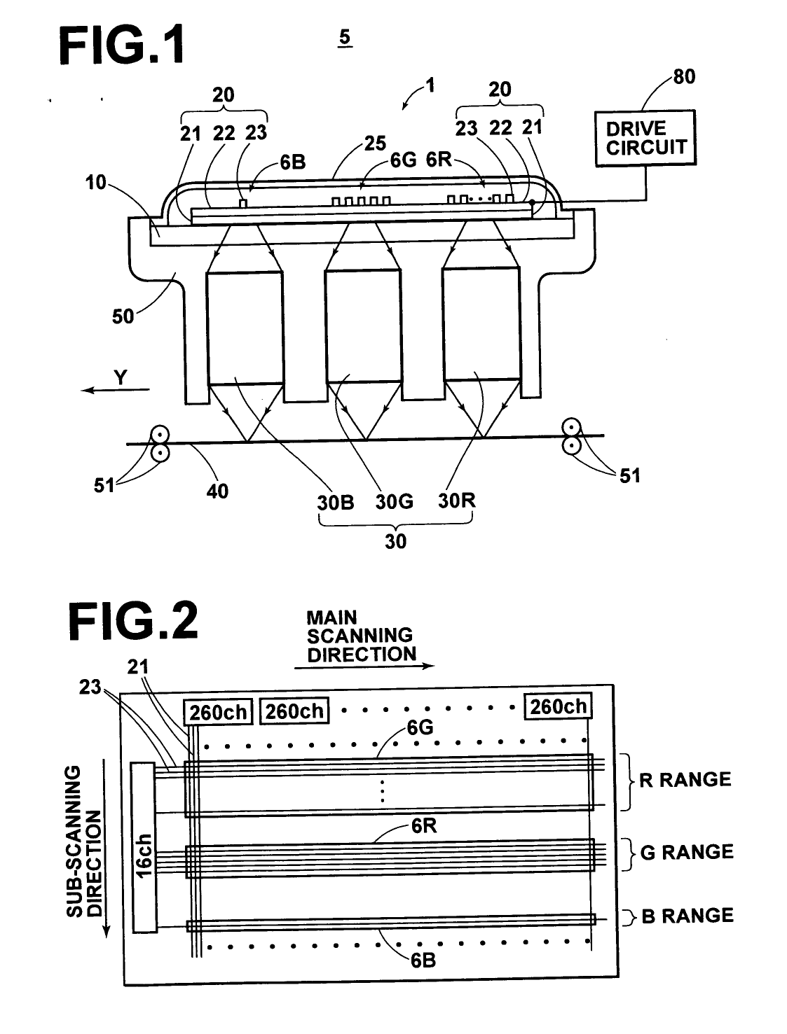

As shown in FIG. 1, an exposure system 5 in accordance with a first embodiment of the present invention has an exposure head 1. The exposure head 1 comprises a transparent base 10, a red emitting element array 6R, a green emitting element array 6G and blue emitting element arrays 6B formed of number of organic EL elements 20 formed on the base 10 by deposition, refractive index profile type lens arrays 30 (30R, 30G and 30B) which are a unit system for imaging on a color photosensitive material 40 an image generated by the light emitted from the organic EL elements 20, and a support 50 which supports the base 10 and the refractive index profile type lens arrays 30.

The exposure system 5 further comprises, in addition to the exposure head 1, a sub-scanning means 51 in the form of, for instance, a pair of nip rollers which conveys the color photosensitive material 40 at a constant speed in a direction of arrow Y.

The organic EL elements 20 comprises an organic compound layer 22 and a metal cathode 23 formed in sequence by deposition on the transparent base 10 formed of, for instance, glass. The organic compound layer 22 includes a transparent anode 21 and a light emitting layer and patterned for each pixel. The elements forming the organic EL elements 20 are arranged in a sealing member 25 which may be, for instance, a can of a stainless steel. That is, the base 10 is bonded to the edge of the sealing member 25 by adhesive and the sealing member 25 is filled with dry nitrogen gas. The organic EL elements 20 are sealed in the sealing member 25.

When a predetermined voltage is imparted between the transparent anode 21 and the metal cathode 23, the light emitting layer included in the organic compound layer 22 emits light, which is taken out through the transparent anode 21 and the transparent base 10. The organic EL element 20 is excellent in wavelength stability. The arrangement of the organic EL elements 20 will be described in detail later.

The transparent anode 21 is preferably not lower than 50% and more preferably not lower 70% in transmittance to visible light in the wavelength range of 400 nm to 700 nm, and may be of known material such as tin oxide, indium·tin oxide (ITO), indium·zinc oxide, and the like. Film of metal such gold, platinum or the like which is large in work function may be employed as the transparent anode. Further, the transparent anode may be of an organic compound such as polyaniline, polythiophene, polypyrrole or a derivative of these compounds. Transparent conductive films shown in “New development of transparent conductive material” supervised by Yutaka Sawada, CMC, 1999, may be applied to the present invention. Further, the transparent anode 21 maybe formed on the base 10 by vacuum deposition, sputtering, ion plating or the like.

The organic compound layer 22 may either be of a single layer of the light emitting layer or may be provided with, in addition to the light emitting layer, a hole injecting layer, a hole transfer layer, an electron injecting layer and/or an electron transfer layer, as desired. For example, the organic compound layer 22 and the electrodes may comprise an anode/a hole injecting layer/a hole transfer layer/a light emitting layer/an electron transfer layer/a cathode, an anode/a light emitting layer/an electron transfer layer/a cathode, or an anode/a hole transfer layer/a light emitting layer/an electron transfer layer/a cathode. Further, each of the light emitting layer, the hole transfer layer, the hole injecting layer and the electron injecting layer may be provided in a plurality of layers.

The metal cathode 23 is preferably formed of metal material which is small in work function, e.g., alkaline metal such as Li or K, or alkaline earth metal such as Mg or Ca, or alloy or mixture of these metals with Ag or Al. In order for the shelf stability and the electron-injectability at the cathode to be compatible with each other, the electrode formed of material described above maybe coated with metal with is large in work function and high in conductivity, e.g., Ag, Al Au or the like. The cathode 23 may be formed by a known method such as vacuum deposition, sputtering, ion plating or the like as the transparent anode 21.

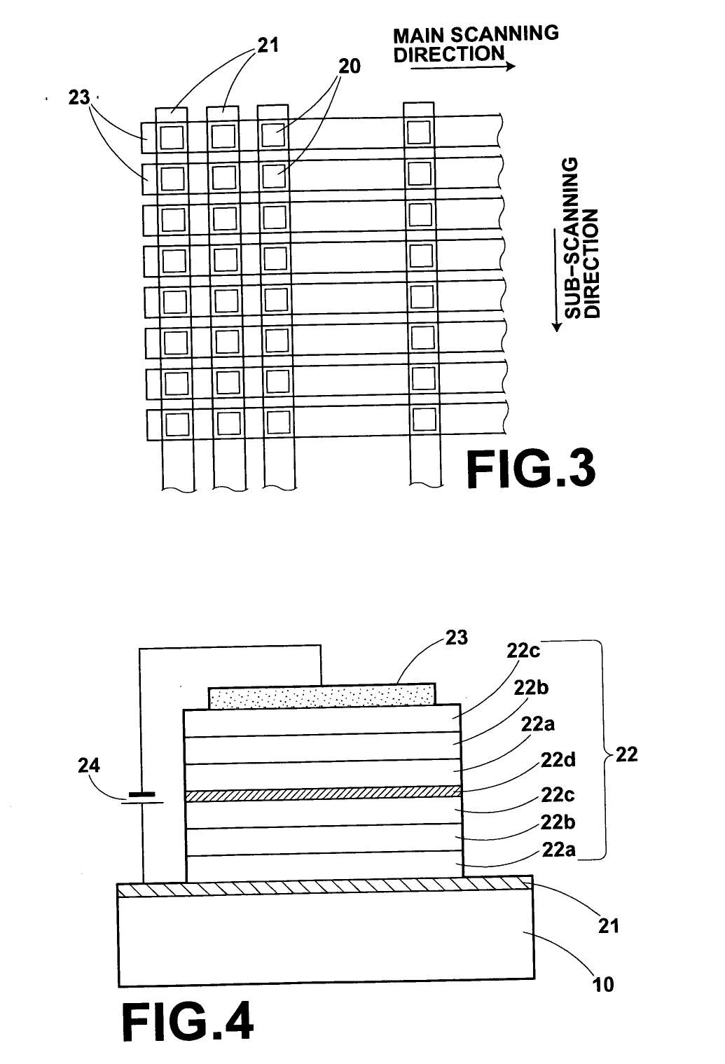

Arrangement of the organic EL elements 20 will be described in detail, hereinbelow. FIG. 2 is a view showing the arrangement of the transparent anodes 21 and the metal cathodes 23 in the exposure head 1 and FIG. 3 is a view showing the arrangement in an enlarged scale. As shown in FIGS. 2 and 3, each of the transparent anodes 21 is patterned into a predetermined shape extending substantially in the sub-scanning direction and common to the organic EL elements 21 arranged in this direction. In this particular embodiment, 7800 (=260×30) of the transparent anodes 21 are arranged in the main scanning direction. Each of the metal cathodes 23 linearly extends in the main scanning direction and common to the organic EL elements 21 arranged in this direction. In this particular embodiment, 16 of the transparent anodes 21 are arranged in the sub-scanning direction.

The transparent anodes 21 and the metal cathodes 23 form column electrodes and row electrodes and a predetermined voltage is imparted by a drive circuit 80 between one of the transparent anodes 21 selected according to the image signal and one of the metal cathodes 23 which are driven in sequence. When a voltage is imparted between one of the transparent anodes 21 and one of the metal cathodes 23, the light emitting layer included in the organic compound layer 22 disposed at the intersection of the transparent anode 21 and the metal cathode 23 applied with the voltage emits light and the light is taken out through the transparent base 10. That is, in this embodiment, one organic EL element 20 is formed at each of the intersections of the transparent anode 21 and the metal cathode 23 and a plurality of organic EL elements 20 are arranged in the main scanning direction at predetermined pitches to form a linear light emitting element array.

As can be understood from the description above, a so-called passive matrix drive system is employed in this embodiment. Since the passive matrix drive system is known, it will not be described in detail, here. It is possible to employ an active matrix drive system in which a switching element such as a TFT (Thin Film Transistor) is employed.

In this particular embodiment, the color photosensitive material 40 is a negative silver halide color paper having a layer including a first photosensitive material which develops in cyan, a layer including a second photosensitive material which develops in magenta, and a layer including a third photosensitive material which develops in yellow. The exposure head 1 of this embodiment is adapted to exposure of a full color image to the color photosensitive material 40. The arrangement for this purpose will be described in detail, hereinbelow.

The organic EL elements 20 comprises those emitting red light, green light and blue light according to the light emitting layer included in the organic compound layer 22. In order to separate the organic EL elements according to the color of light emitted from the organic EL elements, those emitting red light, green light and blue light are sometimes referred to as “the organic EL element 20R”, “the organic EL element 20G”, and “the organic EL element 20B”, respectively, hereinbelow. The first photosensitive material of the color photosensitive material 40 senses the red light emitted from the organic EL elements 20, and develops in cyan, the second photosensitive material senses the green light emitted from the organic EL elements 20, and develops in magenta, and the third photosensitive material senses the blue light emitted from the organic EL elements 20, and develops in yellow.

In this particular embodiment, the organic EL element 20R, the organic EL element 20G, and the organic EL element 20B are a multi-layered type element where a plurality of the organic compound layer 22 are superposed one on another. The arrangement of the organic EL element 20B will be described with reference to FIG. 4, hereinbelow, as an example of the arrangement of the multi-layered type element. The element comprises, as described above, the transparent anode 21, the organic compound layer 22 and the metal cathode 23 formed in sequence on the transparent base 10, and the organic compound layer 22 comprises a pair of light emitting structures laminated together with an electric charge generating layer 22d intervening therebetween. Each of the light emitting structures comprises a hole transfer layer 22a, a light emitting layer 22b and an electron transfer layer 22c. With this arrangement, in this organic EL element 20B, light is taken out from both the light emitting layers 22b when an electric current is flowed between the transparent anode 21 and the metal cathode 23 from a DC power source 24.

In this particular embodiment, though the organic EL element 20B is a two-layered element, the other organic EL elements 20R and 20G are of different layers and are six-layered elements.

The organic EL elements 20R are disposed in R area in FIG. 2 and 7800 organic EL elements 20R are arranged in the main scanning direction to form one linear red light emitting element array and 100 linear red light emitting element arrays are arranged in the sub-scanning direction to form the red light emitting element array 6R. However, in FIG. 1, the number of the linear light emitting element arrays forming the red light emitting element array 6R are shown for the purpose of simplicity.

The organic EL elements 20G are disposed in G area in FIG. 2 and 7800 organic EL elements 20G are arranged in the main scanning direction to form one linear green light emitting element array and 5 linear green light emitting element arrays are arranged in the sub-scanning direction to form the green light emitting element array 6G.

The organic EL elements 20B are disposed in B area in FIG. 2 and 7800 organic EL elements 20B are arranged in the main scanning direction to form one linear blue light emitting element array and 1 linear blue light emitting element array forms the blue light emitting element array 6B.

In this embodiment, the R, G and B areas are formed on one glass base to drive the R, G and B areas in the passive matrix drive independently from and simultaneously with each other. 30 anode drive ICs of 260 channels are provided in a cascade connection in series for driving the transparent anodes of the G area, and one cathode drive ICs of 16 channels is provided for driving the cathode of the G area.

Operation of the exposure system of this embodiment will be described, hereinbelow. In the exposure system 5 shown in FIG. 1, when the color photosensitive material 40 is to be image-wise exposed, the red light emitting element array 6R, the green light emitting element array 6G, and the blue light emitting element array 6B of the exposure head 1 are selectively driven by the drive circuit 80 according respectively to cyan image data, magenta image data, and yellow image data while the sub-scanning means 51 conveys the color photosensitive material 40 in the sub-scanning direction shown by arrow Y at a constant speed.

At this time, an image by red light from the 10 linear red light emitting element arrays of the red light emitting array 6R, an image by green light from the 5 linear green light emitting element arrays of the green light emitting array 6G, and an image by blue light from the blue light emitting element arrays 6B are respectively imaged on the color photosensitive material 40 in a unit magnification by the refractive index profile type lens arrays 30R, 30G and 30B. With this, the areas exposed to the red light are then exposed to the green light and then exposed to the blue light.

As for the exposure to red light, the same place of the color photosensitive material 40 is exposed to red light 10 times by the 10 linear red light emitting element arrays of the red light emitting element array 6R as the color photosensitive material 40 is moved in the sub-scanning direction, and the 10 exposures provide in total a predetermined exposure corresponding to the cyan image data to the place. As for the exposure to green light, the same place of the color photosensitive material 40 is exposed to green light 5 times by the 5 linear green light emitting element arrays of the green light emitting element array 6G as the color photosensitive material 40 is moved in the sub-scanning direction, and the 5 exposures provide in total a predetermined exposure corresponding to the magenta image data to the place. As for the exposure to blue light, a given place of the color photosensitive material 40 is exposed to blue light only once by the blue light emitting element array 6B, and the 1 exposure provides a predetermined exposure corresponding to the yellow image data to the place.

The full color main scanning lines each thus formed are arranged side by side in the sub-scanning direction, whereby the color photosensitive material 40 is recorded with a two-dimensional full color latent image. The latent image is developed to a visible image by a known development means not shown.

The organic EL elements 20R of the red light emitting element array 6R, the organic EL elements 20G of the green light emitting element array 6G, and the organic EL elements 20B of the blue light emitting element array 6B are driven to emit light in a pulse-like fashion, and for instance, by controlling the pulse width, gradation can be generated for each pixel and the color photosensitive material 40 can be recorded with a continuous gradation image.

Prevention of shift of the color balance to elongate the service life of the exposure system in this embodiment will be described, hereinbelow. In this embodiment, the resolution in image exposure is 600 dpi, and the pitches of the pixels in the main scanning direction are 42.3 μm. The light emitting brightness Ir, Ig and Ib required for the red light emitting element array 6R, the green light emitting element array 6G and the blue light emitting element array 6B from the characteristics of the color photosensitive material are as follows.
Ir=18750 cd/m²
Ig=25000 cd/m²
Ib=500 cd/m²

As a result of an advance measurement, the deterioration time constant τr, τg and τb of the first stage of the superposed light emitting structures of the red light emitting element array 6R, the green light emitting element array 6G and the blue light emitting element array 6B are as follows.
τr=100 h
τg=200 h
τb=3200 h

Since the light emitting sizes of the organic EL elements 20R, the organic EL elements 20G, and the organic EL elements 20B are 40×40 μm, 40×40 μm and 40×37.5 μm, the light emitting areas Sr, Sg and Sb are as follows.
Sr=1600 μm²
Sg=1600 μm²
Sb=1500 μm²

Further, as described above, the numbers Nr, Ng and Nb of layers of the superposed light emitting structures of the organic EL elements 20R, the organic EL elements 20G, and the organic EL elements 20B are Nr=6, Ng=6 and Nb=2, and the numbers Mr, Mg and Mb of the exposures by the organic EL elements 20R, the organic EL elements 20G, and the organic EL elements 20B are Mr=10, Mg=5 and Mb=1.

Accordingly, the values of M×N×τ×S for the respective colors are as follows and the same.
Mr×Nr×τr×Sr=9600000 (h·μm2)
Mg×Ng×τg×Sg=9600000 (h·μm2)
Mb×Nb×τb×Sb=9600000 (h·μm2)

Accordingly, even after a plurality of repeated use, the intensity ratio of light between the red light emitting element array 6R, the green light emitting element array 6G and the blue light emitting element array 6B can be held substantially constant and shift of color balance can be prevented. The reason for this is as described above.

Further, in this embodiment, since the light emitting brightness of one light emitting structure is suppressed by employing a multi-layered structure, where a plurality of light emitting structures are superposed one on another, in each of the red light emitting element array 6R, the green light emitting element array 6G and the blue light emitting element array 6B and at the same time the multiple exposure is carried out by forming the red light emitting element array 6R and the green light emitting element array 6G by a plurality of rows of the light emitting elements arranged side by side, the service life of the light emitting element arrays 6R, 6G and 6B is elongated and the service life of the exposure system is elongated. The reason for this is also as described above.

The values in the first embodiment are shown in the following table 1.

TABLE 1

| | M | N | τ (h) | S (μm²) | M × N × τ × S (h · μm²) |
|---|---|---|---|---|---|
| R | 10 | 6 | 100 | 1600 | 9600000 |
| G | 5 | 6 | 200 | 1600 | 9600000 |
| B | 1 | 2 | 3200 | 1500 | 9600000 |

When color photosensitive material is exposed to pulse-width-modulated light as in this embodiment, it is preferred that the following fundamental drive method and the following fundamental exposure method be employed. That is, before shipment of the exposure system, the red light emitting element array 6R, the green light emitting element array 6G and the blue light emitting element array 6B are respectively driven at a suitable constant electric current, and the intensities of the exposure light passing through the refractive index profile type lens arrays 30R, 30G and 30B at this time are measured. And correction coefficients to correct the drive pulse widths to correct the fluctuation in the intensities of the exposure light are obtained. When the color photosensitive material 40 is actually exposed, the exposure light is pulse-width-modulated on the basis of the image data and the correction coefficients.

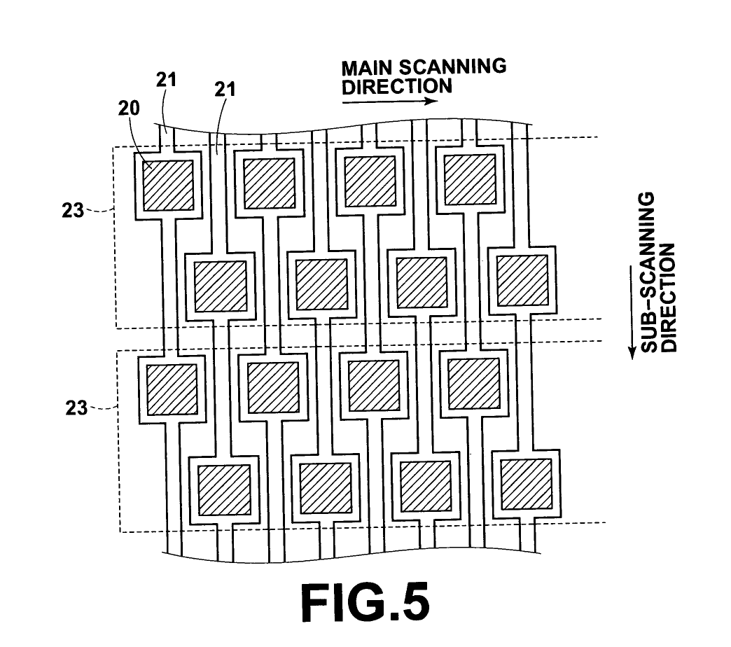

The transparent anodes 21 and the metal cathodes 23 of the organic EL element 20 may be of a shape shown in FIG. 5 as well as a linear shape shown in FIG. 3. In FIG. 5, two rows of the organic EL elements 20 extending in the main scanning direction are formed per one row of metal cathode 23, and the organic EL elements 20 in one row is not spaced from the organic EL elements 20 in the other row in the main scanning direction. In this case, one main scanning line can be exposed without spaces between the pixels, for instance, by driving the exposure system so that the pixels of the odd numbers on the main scanning line are exposed by the organic EL elements 20 in one row and the pixels of the even numbers on the main scanning line are exposed by the organic EL elements 20 in the other row.

### Second Embodiment

An exposure system in accordance with a second embodiment of the present invention will be described, hereinbelow. The second embodiment is basically the same as the first embodiment except that the light emitting size of the organic EL element 20B differs from that in the first embodiment. That is, in this embodiment, the organic EL elements 20R, the organic EL elements 20G, and the organic EL elements 20B are all 40×40 μm in light emitting size. Accordingly, the light emitting areas Sr, Sg and Sb are as follows.
Sr=1600 μm²
Sg=1600 μm²
Sb=1600 μm²

The values of M×N×τ×S for the respective colors are as follows.
Mr×Nr×τr×Sr=9600000 (h·μm2)
Mg×Ng×τg×Sg=9600000 (h·μm2)
Mb×Nb×τb×Sb=10240000 (h·μm2)

Though the value of Mb×Nb×τb×Sb differs from the value of Mr×Nr×τr×Sr or Mg×Ng×τg×Sg, such a small difference is able to prevent color balance in the exposed image from being largely shifted. Generally, when the ratio of the values of M×N×τ×S of the colors is in about 1:2, it is possible to prevent color balance in the exposed image from being largely shifted.

In this case, the blue light emitting element array 6B is driven to provide a brightness of 469 cd/m² (=500 cd/m²×1500/1600), whereby the value of light emitting brightness×light emitting area is equal to that in the first embodiment.

The values in the second embodiment are shown in the following table 2.

TABLE 2

| | M | N | τ (h) | S (μm²) | M × N × τ × S (h · μm²) |
|---|---|---|---|---|---|
| R | 10 | 6 | 100 | 1600 | 9600000 |
| G | 5 | 6 | 200 | 1600 | 9600000 |
| B | 1 | 2 | 3200 | 1600 | 10240000 |

### Third Embodiment

An exposure system in accordance with a third embodiment of the present invention will be described, hereinbelow. The third embodiment is basically the same as the first embodiment except that the values of M, N, τ and S differ from those in the first embodiment.

The values in the third embodiment are shown in the following table 3.

TABLE 3

| | M | N | τ (h) | S (μm²) | M × N × τ × S (h · μm²) |
|---|---|---|---|---|---|
| R | 5 | 12 | 100 | 1600 | 9600000 |
| G | 10 | 3 | 200 | 1600 | 9600000 |
| B | 1 | 1 | 3200 | 3000 | 9600000 |

In this embodiment, since the values of M×N×τ×S for the respective colors are the same as in the first embodiment, it is possible to strictly prevent color balance in the exposed image from being shifted.

### Fourth Embodiment

An exposure system in accordance with a fourth embodiment of the present invention will be described, hereinbelow. The fourth embodiment is basically the same as the first embodiment except that the values of M, N, τand S differ from those in the first embodiment. In this embodiment, the resolution in image exposure is 400 dpi, and the pitches of the pixels in the main scanning direction are 63.5 μm. The light emitting brightness Ir, Ig and Ib required for the red light emitting element array 6R, the green light emitting element array 6G and the blue light emitting element array 6B from the characteristics of the color photosensitive material are as follows.
Ir=12000 cd/m²
Ig=16000 cd/m²
Ib=300 cd/m²

The values in the fourth embodiment are shown in the following table 4. In this embodiment, the organic EL elements 20R, the organic EL elements 20G, and the organic EL elements 20B are all 50×50 μm in light emitting size. Accordingly, the light emitting areas Sr, Sg and Sb are all 2500 μm².

TABLE 4

| | M | N | τ (h) | S (μm²) | M × N × τ × S (h · μm²) |
|---|---|---|---|---|---|
| R | 1 | 7 | 300 | 2500 | 5250000 |
| G | 1 | 3 | 700 | 2500 | 5250000 |
| B | 1 | 1 | 2000 | 2500 | 5000000 |

In this embodiment, since the values of M×N×τ×S for the respective colors are substantially the same, it is possible to strictly prevent color balance in the exposed image from being shifted.

### Fifth Embodiment

An exposure system in accordance with a fifth embodiment of the present invention will be described, hereinbelow. The fifth embodiment is basically the same as the fourth embodiment except that the light emitting size of the organic EL elements 20B differ from that in the fourth embodiment. That is, in the fifth embodiment, the organic EL elements 20B is 50×52.5 μm in light emitting size and 2625 μm² in the light emitting areas Sb.

The values in the fifth embodiment are shown in the following table 5.

TABLE 5

| | M | N | τ (h) | S (μm²) | M × N × τ × S (h · μm²) |
|---|---|---|---|---|---|
| R | 1 | 7 | 300 | 2500 | 5250000 |
| G | 1 | 3 | 700 | 2500 | 5250000 |
| B | 1 | 1 | 2000 | 2625 | 5000000 |

In this embodiment, the blue light emitting element array 6B is driven to provide a brightness of 285.7 cd/m² (=300 cd/m²×2500/2625), whereby the value of light emitting brightness×light emitting area is equal to that in the fourth embodiment.

Though no color filter is used in the embodiments described above, a color filter such as a band pass filter, a low pass filter, a high pass filter or the like may be installed in order to narrow the spectrum of the exposure light to prevent mixing of colors. As the deterioration time constant at this time for each color, the deterioration time constant of the first stage of the superposed light emitting structures under the condition under which the intensity of light after passing through the color filter conforms to the intensity of light necessary to exposure may be used.

An example of the procedure for determining the number M of exposures, the number N of layers of the superposed light emitting structures and the light emitting area S of the light emitting element will be described, hereinbelow.

(1) A light emitting element size is first temporarily determined on the basis of the resolution required to the exposure system (e.g., 600 dpi)

(2) Then exposure energy (light emitting brightness) necessary for each color is calculated taking into account the sensitivity of the photosensitive material, the transmittance of the lens, the exposure speed and the like.

(3) Light emitting elements of a single light emitting structure (N=1) are prepared for the respective colors, and the time constants τthereof at the light emitting brightness calculated in (2) are obtained.

(4) The combination of M and N is determined so that the values of M×N×τ×S for the respective colors are substantially the same.

(5) Further, the values of the light emitting areas S is finely adjusted so that the values of M×N×τ×S for the respective colors further approach.

Since the drive voltage of the organic EL element becomes as large as N times as the number of layers of the superposed light emitting structures becomes N, the value of N must be determined taking into account the withstand voltage of the drive IC in the step (4). Further, it requires a time N times as long as an organic EL element having a single light emitting structure to film a multi-layered organic EL element having N light emitting structures superposed one on another. When taking into account both the withstand voltage and the filming time, the number N of layers should be 10 at most. Further, since, as the number M of exposures is increased, the size of the exposure head in the sub-scanning direction is increased, it is preferred that the number of rows disposed side by side be as small as possible. Accordingly, it is preferred that the number N of layers of the light emitting structures be as large as possible in the range not larger than about 10, and the number M of exposures be as small as possible.

Though, in the embodiments described above, cyan, magenta and yellow are developed by red light, green light and blue light, respectively, it is possible to develop cyan, magenta and yellow by light in other wavelength ranges, for instance, by light in three wavelength ranges in an infrared region and the present invention can be applied also to a so structured exposure system. Further, the present invention can be applied also to an exposure system which is to expose color photosensitive materials other than the silver halide color paper.

Further, the light emitting element arrays may, of course, be formed by light emitting elements other than the organic EL elements and, for instance, elements comprising a combination of an LED and an aperture mask, liquid crystal elements, or PLZT elements may be employed.

While the description above refers to particular embodiments of the present invention, it will be understood that many modifications may be mad without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description. All changes which come within the meaning and range of equivalency of the claims are therefore intended to be embraced therein.

For example, an alternate exposure system may comprise a plurality of kinds of light emitting element arrays, each formed of a plurality of light emitting elements which are arranged in one row in one direction, which are arranged substantially normal to said one direction and emits light in different wavelength ranges, and a sub-scanning means which holds a color photosensitive material in a position where the light from each of the light emitting element arrays is projected, and moves the color photosensitive material and the light emitting element arrays relatively to each other in said one direction in which a plurality of light emitting element arrays are arranged, wherein the improvement comprises that

the light emitting area of the light emitting element is nonuniform between at least two kinds of light emitting element arrays.

It is preferred that at least one of the plurality of kinds of light emitting element arrays comprises a plurality of rows of the light emitting elements arranged side by side in the direction of the above-mentioned relative movement so that the same place of the color photosensitive material can be exposed to light a multiple times. When the system is able to carry out the multiple exposure, it is preferred that the value of M×N×τ×S is substantially the same in each of the plurality of kinds of light emitting element arrays wherein M represents the number of exposure of the same place of the color photosensitive material in each kind of the light emitting element array, N represents the number of light emitting structures in each kind of the light emitting element array, τ represents the deterioration time constant of the first stage of the superposed light emitting structures at the light emitting brightness upon exposure and S represents the light emitting area of the light emitting element in each kind of the light emitting element array.

Further, it is preferred that the plurality of kinds of light emitting element arrays be three kinds of light emitting element arrays respectively emitting light in wavelength ranges of red, green and blue. As such light emitting element arrays, organic EL element arrays are suitable.

Further, in the exposure system of the present invention, it is preferred that silver halide color paper be used as the color photosensitive material.

When at least one of the plurality of kinds of light emitting element arrays in the first or second exposure system comprises a plurality of rows of the light emitting elements arranged side by side in the direction of the above-mentioned relative movement so that the same place of the color photosensitive material can be exposed to light M times, the light emitting brightness of one light emitting element may be 1/M as compared with the case where one place of the color photosensitive material is exposed to light only once, whereby the service life of the light emitting element arrays is elongated to substantially M times and the service life of the exposure system is elongated.

When there is a difference in time constant of deterioration between the plurality of kinds of the light emitting element arrays due to difference in element structure, it is possible to equalize the light emitting element arrays in time constant of deterioration by changing the number M of the exposures in the light emitting element arrays. That is, as the number M of exposures increases, the light emitting brightness or the light emitting time of the light emitting element array can be reduced, whereby the deterioration speed of the light emitting element array can be lowered. If so, the intensity ratio of light in the respective wavelength ranges can be held constant even after a plurality of repeated exposures and shift of color balance can be prevented.

When the same place of the color photosensitive material can be exposed to light a multiple times, the light emitting brightness L can be represented by a formula L=L₀exp (−t/τ) wherein M represents the number of exposure of the same place of the color photosensitive material in each kind of the light emitting element array, N represents the number of light emitting structures in each kind of the light emitting element array, τ represents the deterioration time constant of the first stage of the superposed light emitting structures at the light emitting brightness upon exposure, S represents light the emitting area of the light emitting element in each kind of the light emitting element array, L₀ represents the initial light emitting brightness and t represents the light emitting time. Since there is a relation described above between the values of M, N and S and the light emitting brightness of the light emitting element array, when the value of M×N×τ×S is substantially the same in each of the plurality of kinds of light emitting element arrays, the deterioration speeds of the kinds of light emitting element arrays can be equal to each other, whereby shift of color balance can be more strictly prevented.

What is claimed is:

1. An exposure system comprising a plurality of kinds of light emitting element arrays, each formed of a plurality of light emitting elements which are arranged in one row in one direction, which are arranged substantially normal to said one direction and emits light in different wavelength ranges, and a sub-scanning means which holds a color photosensitive material in a position where the light from each of the light emitting element arrays is projected, and moves the color photosensitive material and the light emitting element arrays relatively to each other in said one direction in which a plurality of light emitting element arrays are arranged, wherein the improvement comprises that
at least one of the plurality of kinds of light emitting element arrays is a multi-layered type light emitting element array where a plurality of light emitting structures are superposed one on another.

2. An exposure system as defined in claim 1 in which at least one of the plurality of kinds of light emitting element arrays comprises a plurality of rows of the light emitting elements arranged side by side in the direction of the relative movement so that the same place of the color photosensitive material can be exposed to light a multiple times.

3. An exposure system as defined in claim 2 in which the value of M×N×τ×S is substantially the same in each of the plurality of kinds of light emitting element arrays wherein M represents the number of exposure of the same place of the color photosensitive material in each kind of the light emitting element array, N represents the number of light emitting structures in each kind of the light emitting element array, τrepresents the deterioration time constant of the first stage of the superposed light emitting structures at the light emitting brightness upon exposure and S represents the light emitting area of the light emitting element in each kind of the light emitting element array.

4. An exposure system as defined in claim 1 in which as the plurality of kinds of light emitting element arrays, three kinds of light emitting element arrays are employed.

5. An exposure system as defined in claim 2 in which as the plurality of kinds of light emitting element arrays, three kinds of light emitting element arrays are employed.

6. An exposure system as defined in claim 3 in which as the plurality of kinds of light emitting element arrays, three kinds of light emitting element arrays are employed.

7. An exposure system as defined in claim 4 in which the three kinds of light emitting element arrays respectively emit light in wavelength ranges of red, green and blue.

8. An exposure system as defined in claim 1 in which the plurality of kinds of light emitting element arrays are organic EL element arrays.

9. An exposure system as defined in claim 1 in which the color photosensitive material is silver halide color paper.

10. An exposure system comprising a plurality of kinds of light emitting element arrays, each formed of a plurality of light emitting elements which are arranged in one row in one direction, which are arranged substantially normal to said one direction and emits light in different wavelength ranges, and a sub-scanning means which holds a color photosensitive material in a position where the light from each of the light emitting element arrays is projected, and moves the color photosensitive material and the light emitting element arrays relatively to each other in said one direction in which a plurality of light emitting element arrays are arranged, wherein the improvement comprises that
the light emitting area of the light emitting element is nonuniform between at least two kinds of light emitting element arrays.

11. An exposure system as defined in claim 10 in which at least one of the plurality of kinds of light emitting element arrays comprises a plurality of rows of the light emitting elements arranged side by side in the direction of the relative movement so that the same place of the color photosensitive material can be exposed to light a multiple times.

12. An exposure system as defined in claim 11 in which the, value of M×N×τ×S is substantially the same in each of the plurality of kinds of light emitting element arrays wherein M represents the number of exposure of the same place of the color photosensitive material in each kind of the light emitting element array, N represents the number of light emitting structures in each kind of the light emitting element array, τrepresents the deterioration time constant of the first stage of the superposed light emitting structures at the light emitting brightness upon exposure and S represents the light emitting area of the light emitting element in each kind of the light emitting element array.

13. An exposure system as defined in claim 10 in which as the plurality of kinds of light emitting element arrays, three kinds of light emitting element arrays are employed.

14. An exposure system as defined in claim 11 in which as the plurality of kinds of light emitting element arrays, three kinds of light emitting element arrays are employed.

15. An exposure system as defined in claim 12 in which as the plurality of kinds of light emitting element arrays, three kinds of light emitting element arrays are employed.

16. An exposure system as defined in claim 13 in which the three kinds of light emitting element arrays respectively emit light in wavelength ranges of red, green and blue.

17. An exposure system as defined in claim 10 in which the plurality of kinds of light emitting element arrays are organic EL element arrays.

18. An exposure system as defined in claim 10 in which the color photosensitive material is silver halide color paper.
